(19) United States
(12) Patent Application Publication
(10) Pub. No.: US 2009/0280303 A1
(43) Pub. Date: Nov. 12, 2009

(54) Compositions For Carton Sealing

(75) Inventors: G. Frederick Hutter, Charleston, SC (US); Jean C. St. Arnauld, Charleston, SC (US); Jane Dobbins, Goose Creek, SC (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MeadWestvaco Corporation, Glen Allen, VA (US)

(21) Appl. No.: 12/297,094

(22) PCT Filed: Apr. 12, 2007
(86) PCT No.: PCT/US07/66526

§ 371 Date: Oct. 14, 2008

Related U.S. Application Data
(60) Provisional application No. 60/745,219, filed on Apr. 20, 2006.

(51) Int. Cl. C09J 193/04; B32B 5/00

(52) U.S. Cl. 428/195.1; 525/54.45

(57) ABSTRACT

The disclosed invention is an adhesive composition that can be applied to a paperboard carton via water-based flexographic or gravure printing, that can subsequently be activated (i.e., melted) by RF radiation during a carton sealing operation, and that provides water-resistant bonding.

This non-provisional application relies on the filing date of provisional U.S. application Ser. No. 60/745,219 filed on Apr. 20, 2006, which is incorporated herein by reference, having been filed within twelve (12) months thereof, and priority thereto is claimed under 35 USC § 1.19(e)

### FIELD OF THE INVENTION

This invention relates to a method for sealing cartons that entails printing an adhesive composition on one or more flaps of an unfolded carton using a water-based flexographic or gravure process, followed by activating the adhesive with radio frequency radiation and folding the flaps to form the sealed carton. Specifically, it discloses adhesive compositions useful in this process that can both be printed by flexographic or gravure processes and subsequently be activated by radio frequency radiation.

### BACKGROUND OF THE INVENTION

Hot melt adhesives are widely used to seal paperboard cartons such as those used to store and transport beer cans, soda bottles, and similar items. The hot melt adhesives have a very rapid set time which makes them highly suited to the high-speed assembly machinery that is used for filling and closing the cartons.

However, hot melt application equipment is subject to frequent plugging. This plugging is the primary cause of stoppages and down time on carton filling machinery.

It would therefore be desirable if an adhesive could be pre-applied to the flaps of cartons that are to be sealed and then be activated in some manner at the point where the sealing is to take place. The ideal way to apply such an adhesive would be during the process wherein the cartons are printed. This would be far more efficient that applying it in a separate manufacturing step. Since most paperboard cartons are printed by flexographic or gravure processes using water-based inks, a reactivatable adhesive that could be applied by this process would be most desirable.

A number of possible ways of producing reactivatable adhesives have been considered in the past, but they have been rejected for various reasons. For example, water-remoistenable adhesives set too slowly because of the high amount of energy needed to drive off the water. Adhesives containing microencapsulated activators have been tried, but their activation speed is limited by the mass transport rate of the encapsulated component.

One way of rapidly reactivating an adhesive would be to melt it by heating with radio frequency (hereinafter RF) radiation. U.S. Pat. No. 6,348,679 and U.S. Pat. No. 6,600,142 disclose methods of sealing various substrates by reactivating a pre-applied adhesive with RF radiation. The adhesive coatings taught in these patents comprise two components: A polar polymer, such as a sulfonated polyester, and a highly polar, non-aqueous carrier. While such adhesives are readily activated by RF radiation due to the aromatic ester bonds in the sulfonated polyesters, they are completely unsuitable for application by flexographic printing due to the presence of the polar carrier. The polar solvents described as carriers U.S. Pat. No. 6,348,679 and U.S. Pat. No. 6,600,142 have very high boiling points whereas flexographic inks require relatively low boiling point solvents in order to dry properly on the press. Typically, in water-based flexography or gravure printing the solvent consists of water and small amounts alcohols containing 1-4 carbon atoms. The polar “carriers” described in the prior art would not evaporate under typical flexographic or gravure printing conditions, and their presence in the printed film would render it tacky and cause blocking problems when the printed cartons are subsequently handled.

An important consideration for an adhesive used on beverage cartons is that the final bond be waterproof. Such cartons are regularly placed in contact with ice, which may be partially melted at times, and it is important that the adhesive holding the carton together not become unstuck. This is not a problem with conventional hot melt adhesives, which are usually water-resistant. However, the compositions disclosed in U.S. Pat. No. 6,348,679 and U.S. Pat. No. 6,600,142, being mixtures of highly polar polymers and highly polar solvents, are very water sensitive and will not stand up to the “dunk test” usually applied to such cartons. As the name implies, this test consists of immersing a carton full of beverage can in water for a set period of time and observing whether any of the adhesive bonds fail.

### SUMMARY OF THE INVENTION

The object of the current invention is to provide an adhesive composition that can be applied to a paperboard carton via water-based flexographic or gravure printing, that can subsequently be activated (i.e., melted) by RF radiation during a carton sealing operation, and that provides water-resistant bonding.

### DESCRIPTION OF THE PREFERRED EMBODIMENT

The object of the present invention is met by providing an aqueous composition comprising two resinous components: (a) a urethane-modified rosin derivative that is insoluble in water but soluble in aqueous base and (b) an acrylic or styrenic latex.

It is well known that polyurethanes will absorb in the RF range. This range includes 13.56 MHz and its harmonics (e.g., 27.12 MHz, 40.68 MHz, etc.) which have been licensed by the FCC for industrial use. Commercial irradiating units have been produced for various applications with operating frequencies as high as 120 MHz. For example, RF at these frequencies can be used to melt polyurethanes for processing.

Partial esters of maleated or fumarated rosin with various polyols are well known and are commonly referred to in the art as maleic resins. Maleic resins are described in detail in Coating and Ink Resins, by W. Krumbhaar (Reinhold, N.Y., 1947), chapter III, which is incorporated herein by reference. Maleic resins with acid numbers of above about 140 are usually soluble in aqueous base but insoluble in water at a neutral pH.

We have found that it is possible to modify such soluble maleic resins for use in the present invention by replacing the polyol with a hydroxyurethane formed from a polyol and a polyisocyanate. This enables the incorporation of urethane functionality into the rosin derivative, thereby making it an antenna for RF radiation.

The preferred way of making the urethane-modified maleic resin is first to react a polyol with a polyisocyanate to form an oligomeric urethane. The polyol/polyisocyanate molar ratio should be chosen so that there is an excess of polyol, thereby yielding an oligomer that is terminated with hydroxyl groups.

The isocyanates suitable for use in this step are generally those that contain from two to about four isocyanate groups. Examples include, but are not limited to hexamethylene diisocyanate, toluene diisocyanate, isophorone diisocyanate, methylenebis(phenylene diisocyanate, methylenebis(cyclohexyl isocyanate), tetramethylxylylene diisocyanate, and mixtures thereof. Isocyanate trimers such as those supplied commercially by Rhodia under the trade name TOLONATE are also useful in this step.

Polyols suitable for use in this step are generally those containing from two to about six hydroxyl groups. Examples include, but are not limited to ethylene glycol, propylene glycol, diethylene glycol, triethylene glycol, dipropylene glycol, tripropylene glycol, cyclohexanedimethanol, neopentyl glycol, butanediol, hexanediol, glycerol, trimethylolethane, trimethylolpropane, ethoxylated trimethylolpropane, ditrimethylolpropane, pentaerythritol, ethoxylated petaerythritol, dipentaerythritol, ethoxylated bisphenol A, propoxyated bisphenol A, and mixtures thereof.

Reaction of isocyanates with alcohols to form urethanes is well known. It can be carried out under mild conditions, usually in from about one to about six hours at between room temperature and 80° C. Aromatic isocyanates and unhindered alcohols tend to react faster and at lower temperatures than aliphatic isocyanates and hindered alcohols. Catalysts can be used to accelerate the reaction. As is well known in the art, tetravalent tin compounds are particularly effective catalysts for this reaction.

If the hydroxyl-terminated urethane produced in this step is too viscous to handle easily, the reaction of the polyisocyanate with the polyol can be carried out in a volatile, aprotic, organic solvent which can be removed by distillation during a subsequent reaction step. Such solvents include, but are not limited to, acetone, methyl ethyl ketone, methyl isobutyl ketone, ethyl acetate, tetrahydrofuran, and mixtures thereof.

In a second step, rosin is reacted with maleic acid, maleic anhydride, or fumaric acid in a known manner as described in the Krumbhaar reference cited above. Generally, the rosin is melted and mixed with the desired amount of unsaturated acid or anhydride, and the mixture is heated at from about 180 to about 230° C. until Diels-Alder adduction of the unsaturated acid or anhydride to the rosin is complete. This usually takes for one to four hours. The rosin used may be gum rosin, tall oil rosin, or wood rosin.

In a third step, the maleated or fumarated rosin from step two and the hydroxyl-terminated urethane from step one are reacted together in an esterification reaction to form the urethane-modified maleic resin. Typical conditions for this esterification reaction are described in the Krumbhaar reference cited above. In general, the reaction mixture is heated at a temperature of about 180 to about 240° C. until the desired acid number is obtained. Typically, this takes from about one to about ten hours. The preferred acid number for the product is from about 120 to about 300, more preferred is from about 130 to about 240.

The urethane-modified, rosin-based resins that are described above are utilized in the present invention in the form of aqueous solutions, where they are dissolved in water at a pH of about 7.5 or higher, preferably a pH of from about 8.0 to about 10.0. The desired pH is obtained by the addition of a fugitive base, such as ammonia, an amine, or an alkanolamine. Typical amines that can be used include, but are not limited to, mono-, di- and trialkylamines containing from one to about 12 carbon atoms, morpholine, and N-alkylmorpholines, where the alkyl group contains from one to about four carbon atoms. Typical alkanolamine that are suitable for use in the invention include, but are not limited to, monoalkanolamines, dialkanolamines, trialkanolamines, alkyldialkanolamines, and dialkylalkanolamines containing from two to about 12 carbon atoms. The use of alkaline solutions of rosin-based resins in flexographic and gravure inks and varnishes well known in the art, and one skilled in the art could readily choose an appropriate amine as needed to adjust the drying time and viscosity of the ink or varnish to meet required press conditions.

The rosin or rosin derivative provides tackiness to the activated adhesive, allowing quick bond formation. It also enhances the water resistance to the final bond because when the neutralizing base evaporates upon drying of the adhesive, the rosin or rosin derivative becomes water-insoluble.

The acrylic or styrenic latex component of the present invention also contributes to the water-resistance of the final bond. It also increases the drying rate of the composition during flexographic printing. These latices are manufactured from styrene, substituted styrenes, acrylic esters, and methacrylic esters by well-known emulsion polymerization methods. Any of the latices of this type that are commonly used in water-based flexographic inks are suitable for use in the present invention. Typical products of this type are commercially available under trade names such as JONREZ (MeadWestvaco), JONCRYL (S.C.Johnson), and RHOPLEX (Rohm&Haas). These acrylic polymers are available with a wide range of glass transition temperature (Tg), generally from −40 to +100° C. For the purposes of the present invention, it is useful to select a resin that is sufficiently hard (high Tg) so that the reactivatable coating will not block when unsealed cartons are stacked during processing or shipment. At the same time, the Tg should not be too low, or it will raise the melting point of the overall coating and thereby increase the reactivation time. The selection of a latex with an appropriate Tg will also depend on the softening points of the other components of the coating, as discussed above, and the relative ratios of the ingredients. One skilled in the art of formulating flexographic and gravure printing inks, where blocking is also an issue, will already be familiar with the properties of these acrylic and styreneic latices, and should be able to select an appropriate latex for a given application.

The two components of the present invention, the urethane-modified, rosin-based resin and the acrylic or styrenic latex can be blended together to make the water-based, flexographically printable by first dissolving the rosin derivative in aqueous base and then mixing the resulting solution with the latex. Alternatively, sufficient water and base to dissolve the rosin derivative can first be added to the latex and the rosin derivative can then be dissolved in the mixture in the presence of the latex.

To function well on a flexographic or gravure printing press, the final blended coating should have a viscosity of about 8 to about 40 seconds as measured with a No. 2 Shell cup. A viscosity of about 18 to about 25seconds is most preferable. The viscosity can be adjusted by the addition of water or small amounts of thickeners, such as polyvinyl alcohol or associative thickeners, whose use will be familiar to one skilled in the art of formulating flexographic or gravure inks.

For stability during the printing process, the pH of the printable adhesive composition should be maintained in a range of about 7.5 to about 10.0. The pH can be adjusted using any of the fugitive bases described above.

With some rosin derivatives, particularly those derived from tall oil, some of the rosin may tend to crystallize out of the mixture on storage. This problem can be eliminated by adding small amounts (preferably <10%) of alcohols containing from one to about four carbon atoms.

### EXAMPLES

The invention may be illustrated by the following examples, which are not to be construed as limiting the invention in any way.

### Example 1

### Preparation of an Aliphatic Urethane-Modified Rosin-Based Resin

Seven hundred fifty-seven grams of ROSIN SS (a tall oil rosin supplied by the Specialty Chemical Division of MeadWestvaco) was charged to a 2-liter flask equipped with a mechanical stirrer and a heating mantle and melted by heating to 160° C. Then 174 grams of maleic anhydride and 1.89 grams of dibutyltin oxide were charged, and the batch was heated for one hour at 185° C. Then 161.3 grams of K-FLEX UD-320-100 was added, and heating was continued for four hours at 200° C. to produce an alkali-soluble, resinous rosin derivative with an acid number of 157. K-FLEX UD-320-100 is a urethane diol manufactured by King Industries by reacting hexamethylene diisocyanate with a diol.

### Example 2

### Preparation of an Aromatic Urethane-Modified Rosin-Based Resin

One hundred seventy-four grams of toluene-2,4-diisocyanate was added slowly with stirring to a solution of 100 grams of ethylene glycol in 100 grams of acetone in a round-bottomed flask. The reaction was exothermic, and the exotherm was controlled by cooling the flask with an ice bath. After the initial exotherm had subsided, the batch was heated to 60° C. and held at that temperature for four hours to produce a viscous solution of a hydroxyl-terminated, aromatic urethane oligomer.

Seven hundred fifty-seven grams of ROSIN SS (a tall oil rosin supplied by the Specialty Chemical Division of MeadWestvaco) was charged to a 2-liter flask equipped with a mechanical stirrer and a heating mantle and melted by heating to 160° C. Then 174 grams of maleic anhydride and 1.89 grams of dibutyltin oxide were charged, and the batch was heated for one hour at 185° C. Then 168.1 grams of the urethane oligomer solution prepared above was added, and heating was continued for one hour at 200° C. to produce an alkali-soluble, resinous rosin derivative with an acid number of 132.

### Example 3

### Preparation of a Flexographically Printable, RF Activatable Adhesive

An aqueous solution of the resin of example 1 was prepared by dissolving 645 grams of the resin in a mixture of 175 grams of concentrated aqueous ammonia and 845 grams of deionized water.

Sixteen hundred fifty-two grams of the above resin solution was added with stirring to 1717 grams of JONREZ E-2069, an acrylic latex supplied by the Specialty Chemical Division of MeadWestvaco, to produce the adhesive.

### Example 4

### Preparation of a Flexographically Printable, RF Activatable Adhesive

An aqueous solution of the resin of example 2 was prepared by dissolving 506 grams of the resin in a mixture of 150 grams of concentrated aqueous ammonia and 663 grams of deionized water.

One hundered nine grams of the above resin solution was added with stirring to 124 grams of JONREZ E-2069, an acrylic latex supplied by the Specialty Chemical Division of MeadWestvaco, to produce the adhesive.

### Example 5

### Printing the RF-Activatable Adhesives

The compositions prepared in examples 3 and 4 were successfully printed on 18 point Carrier Cote board (a grade of paperboard supplied by MeadWestvaco that is used to manufacture beverage cartons) using a Comco Captain pilot scale flexographic printing press. No problems were seen in the transfer of the material into the cells of the anilox roll, transfer of the material from the anilox roll to the plate, or transfer of the material from the plate to the board substrate.

### Example 5

### Testing RF Response

Board coated with the compositions prepared above was tested for RF activation by placing a strip of coated board against a strip of uncoated board, placing these two strips between two blocks of UHMW polyethylene, and securing the blocks with rubber bands (polyethylene and rubber are transparent to RF). The assembly was then subjected to RF radiation of 100 MHz frequency for five seconds in a THERMALL Model 950 machine manufactured by Radio Frequency Company of Millis, Mass. Upon disassembly of the blocks, it was found that there was a fiber-tearing bond between the two pieces of board.

1. An aqueous composition comprising
(a) a urethane-modified, rosin-based resin that is soluble in aqueous base and
(b) an acrylic or styrenic latex,
wherein said composition can be printed on a printing press selected from the group consisting of flexographic or gravure printing presses to form a heat-sealable coating that can be activated by radio frequency radiation.

2. The composition of claim 1 wherein the composition contains from about 10% to about 90% on a solids basis of component (a) and from about 90% to about 10% of component (b).

3. The composition of claim 1 wherein the composition contains from about 20% to about 80% on a solids basis of component (a) and from about 80% to about 20% of component (b).

4. The composition of claim 1 wherein the urethane-modified, rosin-based resin is a reaction product of maleated or fumarated rosin with a hydroxyl-terminated urethane oligomer.

5. The composition of claim 4 where the urethane oligomer is the reaction product of an aliphatic or aromatic isocyanate containing from two to about four isocyanate groups and a polyol containing from two to about six hydroxyl groups.

6. The composition of claim 5 where the polyol is a member is selected from the group of polyols consisting of ethylene glycol, propylene glycol, diethylene glycol, triethylene glycol, dipropylene glycol, tripropylene glycol, cyclohexanedimethanol, neopentyl glycol, butanediol, hexanediol, glycerol, trimethylolethane, trimethylolpropane, ethoxylated trimethylolpropane, ditrimethylolpropane, pentaerythritol, ethoxylated petaerythritol, dipentaerythritol, ethoxylated bisphenol A, and propoxyated bisphenol A, or mixtures thereof.

7. The composition of claim 5 where the isocyanate is selected from the group consisting of hexamethylene diisocyanate, toluene diisocyanate, isophorone diisocyanate, methylenebis(phenylene diisocyanate, methylenebis(cyclohexyl isocyanate), and tetramethylxylylene diisocyanate, or mixtures thereof.

8. The composition in claim 1 where the urethane-modified, rosin-based resin has an acid number greater than about 120.

9. The composition of claim 1 wherein the composition has a viscosity of from about 5 seconds to about eight to about 40 seconds as measured by a No. 2 Shell cup.

10. The composition of claim 1 wherein the composition has a pH of about 7.5 to about 10.0.

11. An article printed by aqueous flexographic or gravure printing using the composition of claim 1.
